(19) United States
(12) Patent Application Publication
(10) Pub. No.: US 2013/0103559 A1
(43) Pub. Date: Apr. 25, 2013

(54) System and Method for Financing Motor Vehicle Registrations

(71) Applicant: Mehdi Roufougar, Romoland, CA (US)

(72) Inventor: Mehdi Roufougar, Romoland, CA (US)

(21) Appl. No.: 13/276,796

(22) Filed: Oct. 19, 2011

(51) Int. Cl. G06Q 40/00

(52) U.S. Cl. 705/35

(57) ABSTRACT

A system and method for financing vehicle registration fees over the foil term of a vehicle purchase or lease financing wherein the system uses a dealer server having a proposal generating program capable of producing a vehicle purchase and a vehicle lease digital proposal a registration server having a registration fee generating program capable of reviewing the digital proposal from the dealer server and based thereon, generating a digital term-registration fee information and a finance server having a finance arrangement program capable of producing a digital financing contract based on the digital proposal and the digital registration fee information. The servers are in mutual communication via a digital communication network wherein the digital proposal, the digital term-registration fee information and the digital financing contract are shared between the servers.

### BACKGROUND

This disclosure relates to the field of retail installment purchase systems and methods and particularly to a method of financing automobile registrations. Usually motor vehicles must be registered with a government authority prior to use. The purpose of such registrations is to establish clear ownership and to tax vehicle owners for their use of public motorways. While almost all vehicles are uniquely identified by a vehicle identification number only registered vehicles display a vehicle registration plate and carry a vehicle registration certificate. Vehicle registration in the United States is managed by each state's motor vehicle agency or an equivalent state governmental agency. Vehicles that are not used on public roads, such as tractors or vehicles whose use is limited to private property, are not always required to be registered. The average cost of license and registration in the United States is currently about $300 per year and this fee may be related to the value of the vehicle. In most U.S. states, a liability insurance policy that meets the state's auto insurance requirements must be purchased before a vehicle may be registered.

A motor vehicle may be purchased for cash. However, more frequently, a consumer purchases a motor vehicle using a financial instrument commonly referred to as a Retail Installment Sale Contract wherein an agreed upon total amount is financed over a period of time, typically 60 months, whereupon the consumer agrees to pay a monthly amount to a financial institution such as a bank, credit union, or other financial organization that has agreed to the financing arrangement. The total amount financed will include the agreed-upon selling price of the vehicle plus certain other fees and taxes such as: a title fee, a license plate fee, a registration fee, a tire fee, an acquisition fee, a delivery charge, short term liability insurance, and sales taxes. The total amount may be reduced by: a trade-in allowance, a down payment, rebates, and credits of various kinds. Liability insurance may be included in the purchase transaction or may be paid by the dealer (the seller) for a few days or typically about one week, after the purchase until the purchaser is able to acquire his/her own insurance policy.

Typically, the new or used vehicle dealer (commercially licensed seller) makes ail of the financial and registration arrangements so that a purchaser need only make an initial payment, usually in the form of a check, credit card payment or other financial instrument, and is then able to drive away in the purchased vehicle. Alternately, the purchaser may arrange his/her own financing without the help of the dealer. In this case the financial arrangements are made prior to contracting with, the dealer. In either case, it is the dealer who specifies the total amount to be financed and this may include the vehicle registration fee or fees.

It is also a common practice for a consumer to lease a motor vehicle using a financial instrument commonly referred to as a Motor Vehicle Lease Agreement wherein lease payments are paid monthly. Whether the deal is an outright purchase or a lease, a vehicle registration is typically required and the registration fee is paid by the buyer for the first year of operation of the motor vehicle, this fee is normally included as part of the financing or leasing agreement. The owner or leasee of the vehicle is obligated to pay an annual registration fee as long as the vehicle is owned and operated on public roads. Upon resale of the vehicle, the new owner is obligated to pay the annual registration fees.

### SUMMARY OF THE INVENTION

A system and method for financing motor vehicle registrations includes several computer servers operated by mutually independent entities and the computer programs that provide the several operating steps involved. The system also includes the Internet as a communication channel which ties the servers together for mutual data transfers which are necessary to the method.

The entities include: a department of motor vehicles (DMV) or the equivalent thereof depending on which state is involved, an automobile dealership (dealer), and a financial lending institution such as a bank or credit union, or vehicle manufacturer lending arm (lender) and, of course, a purchaser or leasee (buyer) of a motor vehicle. The respective computer servers of these entities communicate with each other via the Internet so as to carry out the claimed method which provides certain advantages and benefits as will be described herein. In this writing, when one or another of the entities is discussed as to taking an action of one sort or another, it is to be understood that the action is executed by the entity's server, unless otherwise specified, as the act invariably involves the transfer of digital data or information between the servers. It should be understood that the entities may be in close proximity to each other or may be distant and that the entity's server's may, or may not, be close to the location of their respective entities,

The overall objective of the method is to provide advantages to each of the above entities as will be defined and shown herein. The method provides for the financing of all annual vehicle registration fees that will come due during the term of the vehicle purchase or lease contract. This initially assumes that the purchaser will remain the owner-operator of the vehicle during that term. As described in the background discussion above, we see that it is a universal convention whereby the vehicle owner pays vehicle registration fees on an annual basis during the ownership of a vehicle. In contrast, in the present method, where the vehicle cost for purchase or lease is financed over a term, typically 60 months for purchase and 36 months for lease, the financed amount includes the vehicle registration fees during the entire term. During the finance or lease term, the owner/leasee will not be required to pay registration fees, but at the end of the finance or lease term, the vehicle's owner-operator will be required to assume the payment of annual registration fees.

One aspect of the present system and method is that vehicle registration fees that are, or will come, due during the term of a financed purchase or lease are included in the financing or lease arrangement.

Another aspect of the present system and method is that the vehicle buyer or leasee need not pay vehicle registration fees during the financing or lease term which has the advantage of not requiring dealing with the governmental office through which such payments are made.

Another aspect of the present system and method is that a resale of the vehicle during the term of the financing or lease term will include pre-paid vehicle registration fees over the balance of the term which may appear as a benefit to a prospective next buyer potentially making the resale or lease takeover more attractive.

Another aspect of the present system and method is that the governmental office that receives vehicle registration fees will receive a significantly increased revenue flow at the point of vehicle purchase instead of smaller payments spread over the term of vehicle financing or leasing. As will be shown, this increase in revenue is highly attractive to the state.

Another aspect of the present system and method is that the financial institution tendering the financing of the vehicle will receive increased financing fee revenue over the term of the contract due to financing a larger principal amount.

Another aspect of the present system and method is that the vehicle dealer will receive greater sales fees due to the larger financed amount at the point of sale or lease.

The details of one or more embodiments of these concepts are set forth in the accompanying drawings and the description below. Other features, objects, and advantages of these concepts will be apparent from the description and drawings, and from the claims.

### DESCRIPTION OF DRAWINGS

FIG. 1 is an example block diagram of the presently described system;

FIG. 2 is a partial view of an example of a motor vehicle retail installment sales contract;

FIG. 3 is a partial view of an example of a motor vehicle lease agreement;

FIG. 4 is an example block diagram showing the data transfers of the presently described method used by the system; and

FIG. 5 is a logic flow diagram of the presently described process or method.

Like reference symbols in the various drawings indicate like elements.

### DETAILED DESCRIPTION

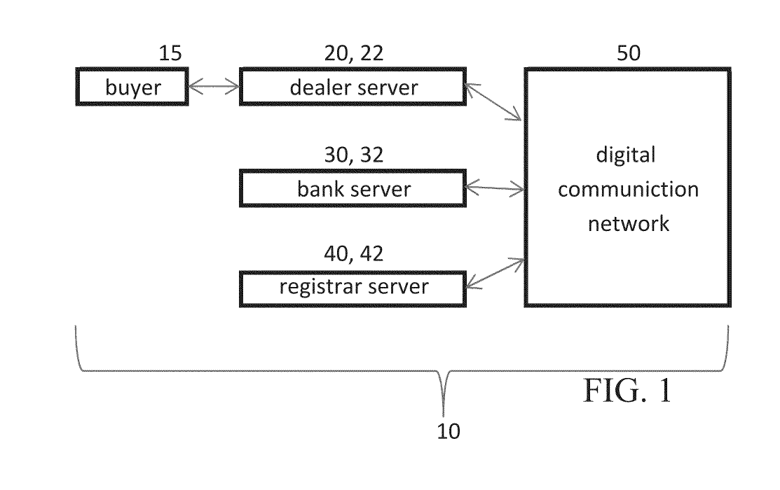

FIG. 1 illustrates the presently described system 10. System 10, as will be described, uses a method for financing a vehicle purchase or lease. The amount financed includes the vehicle registration fees over the full term of the vehicle finance or lease.

The system 10 comprises four entities including a buyer or leasee 15 referred to herein by the term “buyer,” a dealer 20, a bank 30 and a registrar 40. Each of the dealer 20, the bank 30 and the registrar 40 operate their own computer server as shown in FIG. 1, where the respective servers are identified by the same reference numerals as the entities. The buyer 15 may be a consumer interested in purchasing or leasing a vehicle for private or business use, or a fleet buyer interested in leasing one or more vehicles for fleet operations. The dealer 20 is typically a commercial vehicle seller of new and, or used automobiles or trucks. The bank 30 is any financial institution that offers financial services for financing vehicle purchases or leases. The registrar 40 is typically a state-owned and operated vehicle registration operation such a Department of Motor Vehicles (DMV). However, the registrar 40 may alternately be a private entity licensed by the state.

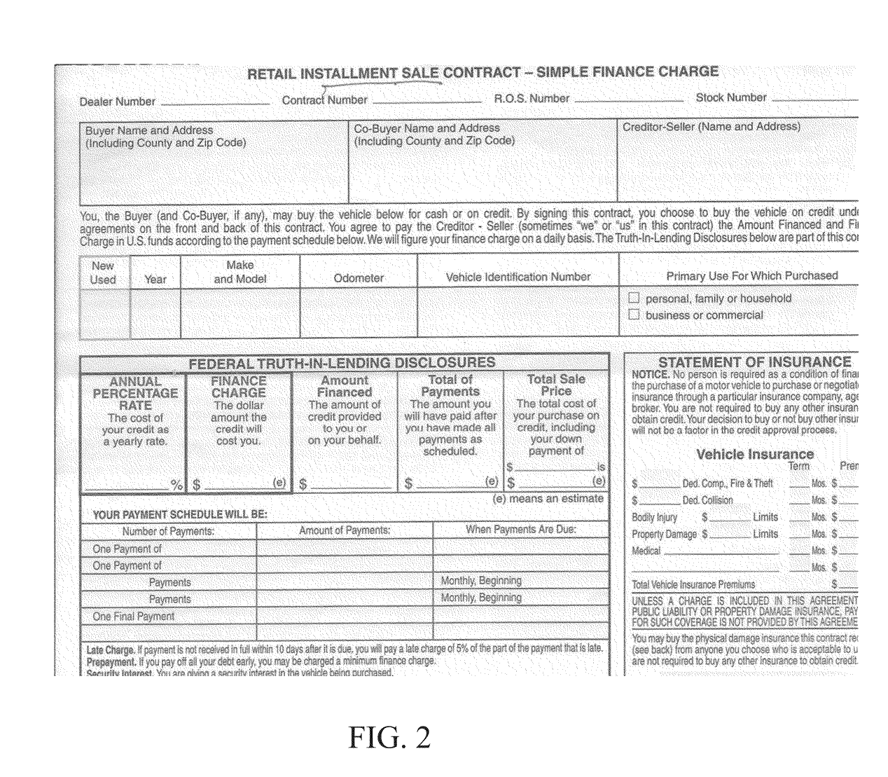

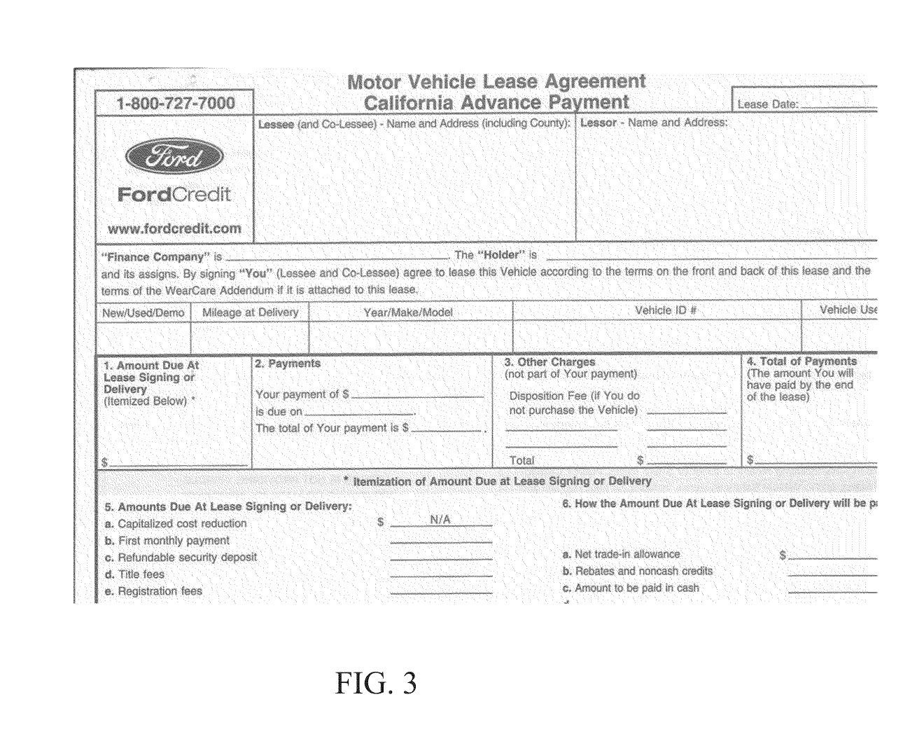

The servers of the dealer 26, bank 30 and registrar 40 have independent operating software programs that are functionally enabled for processing information and sharing this information in digital form with each other. Such information is transferred as digital signals over a wide area network such as the Internet. A dealer program 22 is able to produce a legal proposal document, for instance, a MOTOR VEHICLE RETAIL INSTALLMENT SALES CONTRACT, FIG. 2, and a MOTOR VEHICLE LEASE AGREEMENT, FIG. 3. These documents reside in template form within memory space in dealer server 20. When needed, program 22 makes a copy of the respective document from memory and “fills-in” the document from keyed-in information which is shown on a display screen and which is then captured in server memory as an electronic proposal document referred to herein as a “proposal.”

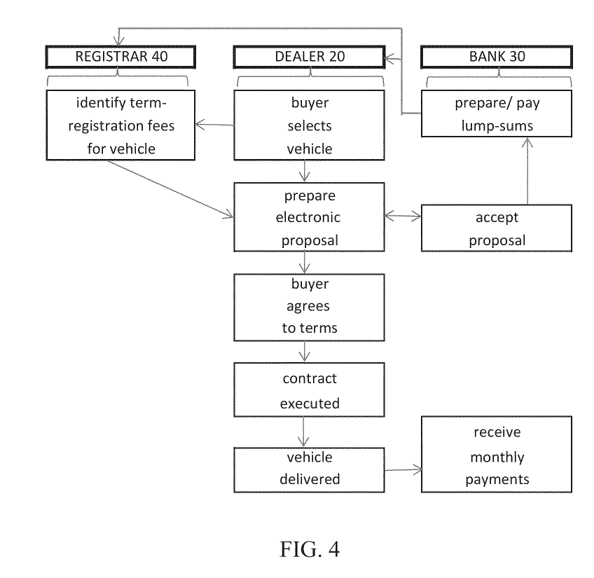

Typically the financing of a vehicle purchase or lease does not include financing the vehicle registration fee. If it does, the fee included is only for the first year. In the present method, the registration fee is for the full term of the financing arrangement usually either three or five years. Therefore, three or five years of vehicle registration fees are included in the amount financed. FIG. 4 illustrates how the dealer server 20 arrives at the amount to be financed. As shown, first the buyer 15 selects the vehicle to be purchased or leased. Vehicle information such as vehicle sales price, age, new or used, weight, make and model, and financing information such as the financing term are inputted into the proposal. The proposal is sent to the registrar server 40 where a vehicle registration fee for the term of the selected vehicle over the term of the financing is generated by the registration server program.

At this time, the dealer program produces a total financed amount which is included in the proposal. The bank server 30 receives the proposal from the dealer server 20 and recognizes key variables such as: amount to be financed, term, and a requested interest rate, among other proposal variables. Program 32 is also able to recognize these variables as well as the buyer's financial credit score. The amount financed includes the agreed upon price of the vehicle, and typical other amounts such as destination delivery and preparation charges less a down payment and possibly credits such as dealer incentives. The amount financed also includes the vehicle registration fee over the full term of the financing which for a purchase is typically five years, and in the case of a lease is typically three years. Program 32 compares the values of variables in the proposal with acceptable limits within the program as defined by the bank 30, and if all the variables are within acceptable limits, the proposal is accepted and an acceptance transmission is made from bank server 30 to dealer server 20. If one or more variables is outside the acceptable limits, the proposal is not accepted and a reason why is transmitted to the dealer program 22. Program 22 may have the ability to adjust variables by itself and try again, or changes may be solicited to the buyer 15 or independently made by the dealer 20 to replace original values and the proposal may then be again submitted to the bank program 32. In most cases, adjustment of variable terms or change of the bank 30 will result in an accepted proposal.

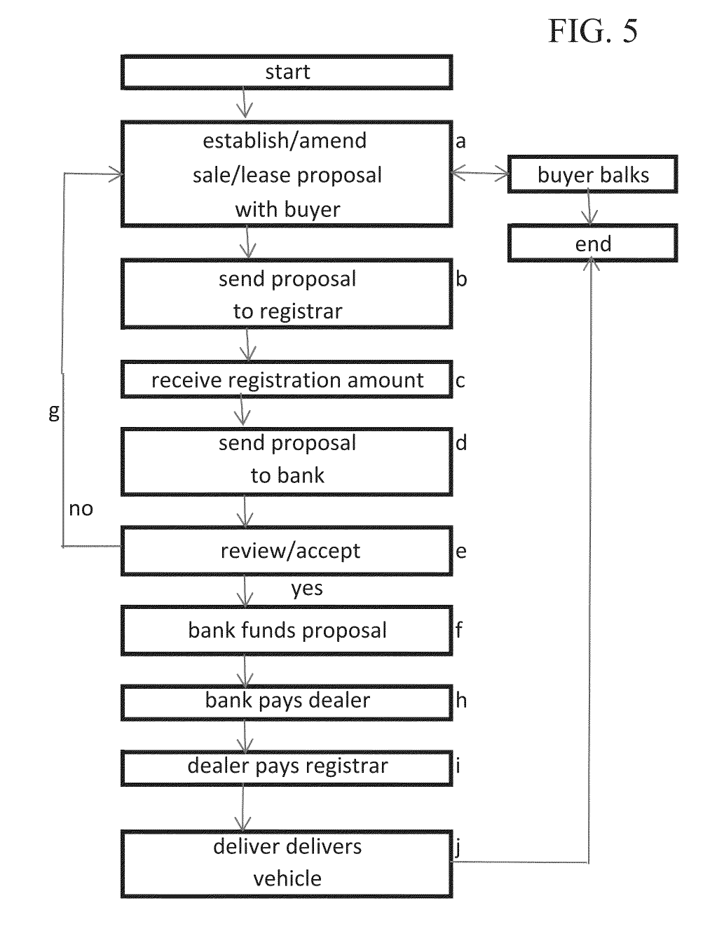

In this description, bank 30 may represent one, or more than one, financial institution. The dealer may “shop” the “deal.” When dealer server 20 receives an acceptance from bank server 30, an unchanged or adjusted proposal that already has been signed by the buyer 15 becomes a legal contract for purchase or lease. When the proposal has been changed or adjusted but is now acceptable to buyer 15, it becomes a legal contract when the buyer 15 signs it. It is stressed here that except for manually inputting buyer and vehicle information into the electronic proposal document, all steps in the present method are taken by electronic transfers and digital processing. There is a critical reason for this. As in many sales situations, a prospective buyer is liable to change his/her mind at any point. In the automobile sales industry this is particularly true since most prospective buyers shop for a best deal and have seen many competitive offerings prior to the current negotiation. If the time duration for obtaining an acceptable proposal is extensive, the buyer 15 is likely to balk, see FIG. 5, and cut-off negotiations. The buyer 15 may have a high propensity for moving on to a different dealer 20. Assuming that the dealer server 20, bank server 30 and registrar server 40 are all up and running and on line at the time of a particular vehicle sales negotiation between buyer 15 and dealer 20, the time required to obtain a term-registration fee amount can be between five and thirty seconds, the time required to produce the proposal with the term-registration fee included can be as little a few more seconds. When the buyer approves the proposal, the time required to obtain bank approval may be only a minute or so. The ability to create a ready-to-sign contract is able, by the methods described herein, to prevent loss of attention, attitude, and interest by the buyer 15. This is the great value in the present method that is totally outside the realm practicality should the method be practiced manually.

FIG. 4 illustrates the dynamic processing of information that occurs in order to reach a final decision in the “deal” in order to complete the proposal and to achieve a legal contract. The decision makers, traditionally, are the buyer 15, the dealer 20, and the bank 30. In the traditional process, the registrar 40 does not play a role in the purchase or lease decision for a vehicle. This is because the buyer 15 knows that an annual vehicle registration fee must be paid and that the first annual registration fee must be paid at the time of purchase or shortly thereafter. If this fee, typically $300 is included in the financing, it will not significantly affect the monthly payment made by the buyer. The newly purchased vehicle must have a valid license plate in order to use public thoroughfares. Typically, until the vehicle can be registered the buyer may use “dealer plates” or just show a temporary registration paper taped to the vehicle's windshield.

However, in the present method, the registration fee over a five year period may be about $1500 which for a vehicle costing $10,000 will add significantly to the buyer's monthly payment. Financing this extra amount may inhibit some buyers 15, but there are compensating issues that, when seriously considered may make the deal more attractive. First of all, the fact that the registrar 40 receives a lump-sum of all registration fees over the financing term (term-registration) may enable the fee to be significantly lower then the sum of the separate fees that would be paid over the financing term. Second, paying the fees now avoids fee increases due to inflation and other factors. Finally, not having to endure trips to the Department of Motor Vehicles to pay registrations is important to some buyers 15.

The registration server 40 stands-by to receive requests for term-registration fees from dealer servers 20. As shown in FIG. 5, an initial proposal is agreed to between dealer 10 and buyer 15, step “a.” The proposal is sent to the registration server 40 in step “b” where the term-registration fee for the identified vehicle is calculated and sent to the dealer server wherein at step “d” the proposal is sent to the bank server 30. In step “c” the proposal is reviewed by program 32 and if rejected, as shown by path “g” the terms of the proposal are renegotiated with buyer 15 by dealer 20. If in step “e” the proposal is accepted by program 32, the proposal is funded in step “f.” The bank 30 then pays the dealer 20 in step “h” and the registrar 40 in step “i.” The dealer 20 then delivers the vehicle to the buyer 15.

Embodiments of the subject apparatus and method have been described herein. Nevertheless, it will be understood that various modifications may be made without departing from the spirit and understanding of this disclosure. Accordingly, other embodiments and approaches are within the scope of the following claims.

1. A system of computer servers in mutual communication for producing a multi-year automobile purchase financing contract on a vehicle purchase, the contract defining a multi-year term and periodic payments against a principal amount, wherein the principle amount includes both a vehicle cost and a vehicle registration fees, the registration fees covering the multi-year term of the contract, the system comprises:
a dealer server having a sales proposal generating program stored in memory, the sales proposal generating program, when executed by a processor of the dealer server, causes the dealer server to produce a vehicle purchase proposal having periodic payments over a multi-year term of purchase;
a registration server having a registration fee generating program stored in memory, the registration fee generating program, when executed by a processor of the registration server, causes the registration server to review the vehicle purchase proposal of the dealer server and to generate a registration fee amount equal to a total of all annual registration fees over the multi-year term of purchase; and
a finance server having a finance contract program stored in memory, the Finance contract program, when executed by a processor of the finance server, causes the finance server to produce financing contract based on the vehicle purchase proposal of the dealer server, and the registration fee amount of the registration server.

2. (canceled)

3. A system of computer servers in. mutual communication, for producing a multi-year automobile leasing contract, the contract defining a multi-year lease term and periodic payments, wherein the payments include both a cost of leasing and a vehicle registration fees, the registration fees covering the multi-year lease term of the contract, the system comprising:
a dealer server having a lease proposal generating program stored in memory, the lease proposal generating program, when executed by a processor of the dealer server, causes the dealer server to produce a vehicle lease proposal having periodic lease payments over a multi-year term of the lease;
a registration server having a registration fee generating program stored in memory, the registration fee generating program, when executed by a processor of the registration server, causes the registration server to review the vehicle lease proposal of the dealer server and to generate a registration fee amount equal to a total of all annual registration fees over the multi-year term of the lease; and
a finance server having a lease contract program stored in memory, the lease contract program, when executed by a processor of the finance server, causes the finance server to produce a leasing contract based on the vehicle lease proposal of the dealer server, and the registration fee amount of the registration server.

4. A method, using computer servers in mutual communication, for producing a multi-year automobile purchase financing contract on a vehicle purchase, the contract defining a multi-year term and periodic payments against a principal amount, wherein the principal amount includes both a vehicle cost and a vehicle registration fees, the registration fees covering the multi-year term of the contrast, the method comprising:
executing a sales proposal generating program on processor of a dealer server thereby producing a vehicle purchase proposal including a price for a specific vehicle, the proposal including periodic payments over a multi-year term of purchase;
executing a registration fee generating program on a processor of a registration server using the vehicle purchase price for the specific vehicle as input information, thereby producing a registration fee amount equal to a total of all annual registration fees over the multi-year term of purchase for the specific vehicle; and
executing a finance contract program on a processor of a finance server using, the vehicle purchase price and the registration fee amount as input information, thereby producing a financing contract for paying the purchase price and the registration fee amount together as periodic payments over the multi-year term of purchase.

5. A method, using computer servers in mutual communication, for producing a multi-year automobile lease contract on a vehicle lease, the contract defining a multi-year term and periodic lease payments, wherein the lease payments include both a vehicle leasing fee and a vehicle registration fees, the registration fees covering the multi-year term of the lease, the method comprising:
executing a lease proposal generating program on a processor of a dealer server thereby producing a vehicle lease proposal including a lease fee for a specific vehicle, the proposal including periodic lease payments over a multi-year term of the lease;
executing a registration fee generating program on a processor of a registration server using the vehicle lease fees for the specific vehicle as input information, thereby producing a registration fee amount equal to a total of all annual registration fees over the multi-year term of the lease for the specific vehicle; and
executing a finance contract program on a processor of a finance server using the vehicle lease fees and the registration fee amount as Input information, thereby producing a financing contract for paying the lease lees and the registration lee amount, together as periodic payments over the multi-year term of purchase.
